(19) United States
(12) Patent Application Publication
(10) Pub. No.: US 2003/0143020 A1
(43) Pub. Date: Jul. 31, 2003

(54) Window wiper system and method for the production thereof , especially for a motor vehicle

(76) Inventors: Kurt Muehlpforte, Buehl (DE); Jan Dietrich, Buehl (DE); Hubert Lorenz, Sinzheim-Kartung (DE); Tino Boos, Baden-Baden (DE)

Correspondence Address: KENYON & KENYON, ONE BROADWAY, NEW YORK, NY, 10004, US

(21) Appl. No.: 10/182,089

(22) PCT Filed: Nov. 10, 2001
(86) PCT No.: PCT/DE01/04224

(30) Foreign Application Priority Data
Nov. 25, 2000 (DE) 100 58 644.9

(51) Int. Cl. B25G 3/34; F16B 11/00

(52) U.S. Cl. 403/265

(57) ABSTRACT

Windshield wiper system, in particular, for a motor vehicle, and method for manufacturing a windshield wiper system of this type, having a carrier that is formed at least partially in the shape of a hollow section (10), and having at least one wiper bearing (12) that is provided with at least one projection (28). The projection (28) has at least one recess (38) and is at least partially inserted into the hollow section (10), with the hollow section (10) having at least one hole (46) located in the area of the recess (38); and with casting material that is shaped outside the hollow section (10) being injected through the hole (46) into the recess (38).

### BACKGROUND INFORMATION

The present invention relates to a windshield wiper system and to a method for manufacturing a windshield wiper system according to the definition of the species in the independent claims. A number of such windshield wiper systems is already known, where a wiper bearing is provided with a projection that has recesses and is inserted into a tubular blank in the form of a hollow section. After the projection is inserted into the hollow section, pressure is typically applied to the recess area, thereby crimping the wiper bearing against the tubular blank. This is shown, for example, in German Patent 41 41 385 A1.

### ADVANTAGES OF THE INVENTION

The windshield wiper system according to the present invention, having the features of the main claim, has the advantage that casting material is injected into the recess in the projection of the wiper bearing through a hole provided in the hollow section. This produces a connection of especially high strength and durability. The apparatus remains vibration-proof, even when the material strength decreases.

The features described in the subordinate claims provide advantageous embodiments and refinements of the features indicated in the main claim.

It is especially advantageous for the recess to be larger than the hole width, thus preventing the casting material from falling out of the recess through the hole after injection.

It is also advantageous to design the entire projection in the shape of a cylinder up to an at least partially circumferential annular groove in the area of the hole, in the inserted position. This ensures that the projection is easily insertable into the hollow section, which, in this case, is in the form of a tube. This produces a tight fit against the inside walls of the hollow section after casting.

If a recess extends through the full length of the projection, transversely to its longitudinal extension, then a cross bolt is produced following the casting operation. The cross bolt efficiently holds the wiper bearing in place in the tubular blank.

It is particularly advantageous for the projection to have two diametrically opposed trough-like recesses, which are disposed transversely to its longitudinal extension and are connected by at least one opening.

If the hollow section is designed as a tube, and if the casting material extends outside the hollow section in the form of a ring segment or ring, the shrinkage occurring as the casting material cools, locks the individual ring segments in place. This is especially advantageous if the hollow section has holes that are largely uniformly distributed around its circumference.

A similar design is, of course, also possible using rectangular or square sections or any other section shape.

Using a casting material that is made of a zinc alloy produces a corrosion-resistant connection made of a suitable material for casting. Of course, it is also possible to use any other fluid and curable material, including not only metals and metal alloys, but also plastics such as epoxy resin. High-shrink casting materials are also usable by suitably forming the recesses.

It is also advantageous for the casting material outside the carrier tube to be formed into an attachment bracket, particularly if the attachment bracket includes attachment means such as attachment holes or lugs that serve to hold screws, rivets, clamps or similar devices.

The method according to the present invention, having the features of Claim 10, has the advantage that it is a simple and economical method for achieving a highly stable and resistant coupling between a wiper bearing and a tubular blank.

In addition, forming the casting material into a ring segment, for example a complete ring, further strengthens the connection between the wiper bearing and tubular blanks, since the casting material produces an additional clamping effect as it shrinks.

Using a zinc alloy as the casting material makes it possible to advantageously employ typical diecasting methods.

It is also advantageous to form the casting material outside the carrier tube in a way that produces an attachment bracket for attaching the windshield wiper system. In addition, attachment holes may be used to hold screws, rivets, clamps or similar devices.

### DRAWING

An exemplary embodiment of the present invention is illustrated in the drawing and explained in greater detail in the following description, where:

FIG. 1 shows a typical windshield wiper.

FIG. 2 shows a perspective view of a carrier and wiper bearing of a windshield wiper.

FIG. 3 shows a side view of a carrier and wiper bearing of a windshield wiper according to the present invention.

FIG. 4 shows a side view of an assembled carrier and wiper bearing.

FIG. 5 shows a cross-section of the carrier illustrated in FIG. 4.

FIGS. 6a and 6b show the shaped area of the casting material, including attachment brackets, viewed from the side.

### DESCRIPTION OF THE EXEMPLARY EMBODIMENT

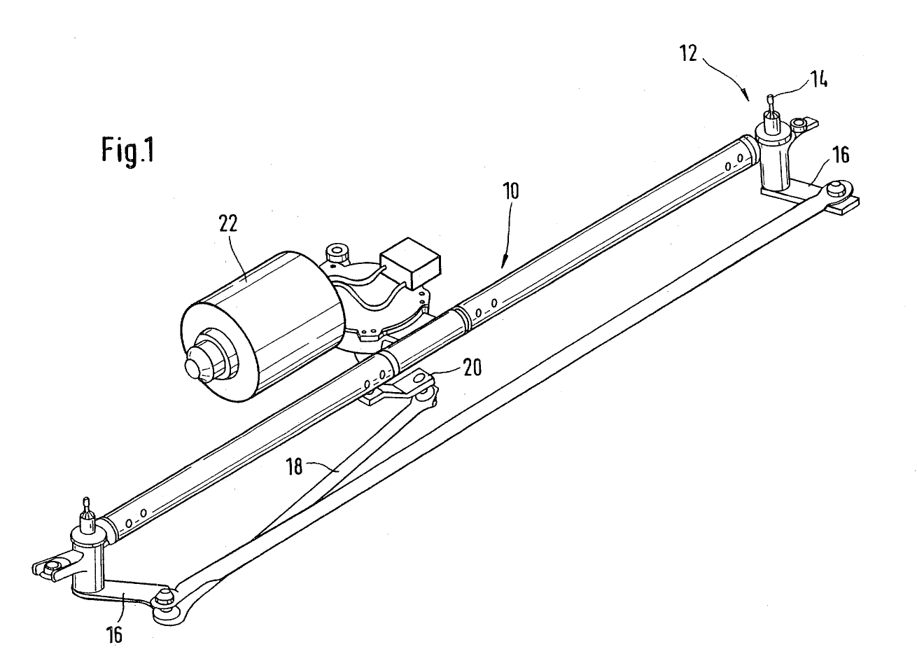

FIG. 1 shows a schematic representation of a typical windshield wiper system. It includes a carrier 10 that is designed as a hollow section and formed into a tube in the typical manner. It has two ends, with one wiper bearing 12 attached to each one. A wiper shaft 14, to which a wiper arm (not illustrated here) having a wiper blade may be attached, is arranged in wiper bearing 12. Wiper shaft 14 is driven by pivoted lever 16, which is set in reciprocating motion by a wiper motor 22 via a connecting rod 18 and a crank 20.

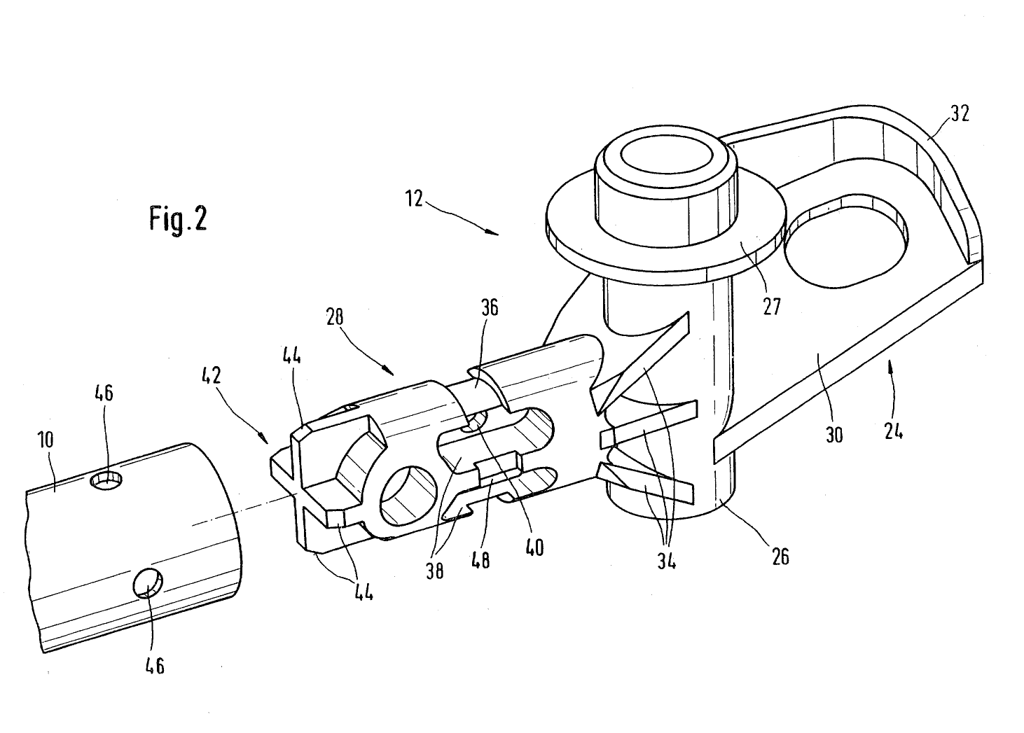

FIG. 2 shows a detailed representation of wiper bearing 12 and the end of a carrier 10.

Wiper bearing 12 has three main areas—an attachment area 24, a bearing muff 26 and a projection 28—and is made, for example, of cast plastic. Bearing muff 26 largely includes a short tubular piece of a cylindrical shape, which bears the wiper shaft (not illustrated). In the upper part of the short tubular piece of the bearing muff 26, an annular plate 27 is formed in one piece on bearing muff 26, surrounding the tubular piece like a rim.

Largely cylindrical projection 28 is formed onto bearing muff 26 roughly perpendicular to the center axis of cylindrical bearing muff 26. Attachment area 24 is provided as a largely flat plate 30 at the end of bearing muff 26 facing projection 28. Plate 30 has a collar 32 on one side.

Projection 28 is formed onto bearing muff 26 by three cast girders 34 as reinforcement. More or less in the center of its longitudinal extension, the projection has an annular groove 36, which runs around the entire circumference of projection 28. Overlapping this annular groove 36, projection 28 has a total of four trough-like recesses 38, positioned opposite each other and partially interconnected in their base regions. Both diametrically opposed trough-like recesses 38, in particular, are interconnected in their base regions by an opening 40 in the form of a bore.

At the end of bearing muff 26 facing away from projection 28, the muff tapers to a cross structure 42, which is positioned concentrically to the center axis of projection 28. At its four outer edges, cross structure 42 has a chamfer 44 to facilitate insertion into carrier 10.

Carrier 10 includes a tube whose wall has four holes 46 that are evenly distributed around its circumference. The inner diameter of tube 10 is at least the same size as the outer diameter of projection 28 of wiper bearing 12, at least in the end regions.

When projection 28 of wiper bearing 12 is inserted into carrier tube 10, holes 46 in the end position are located directly over annular groove 36, where trough-like recesses 38 are also located.

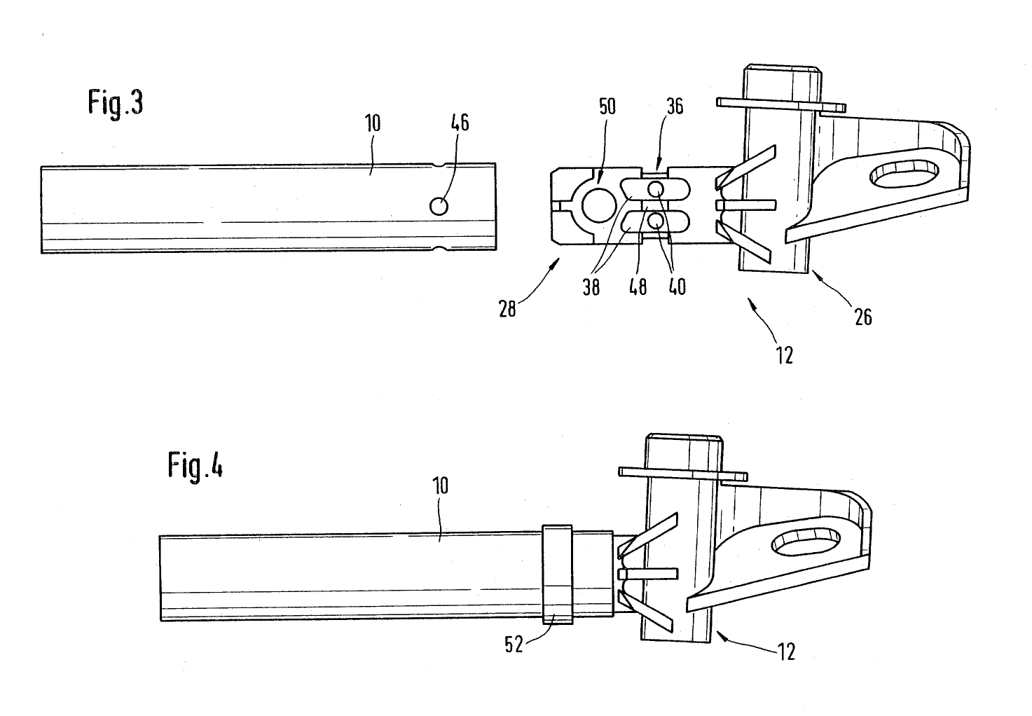

FIG. 3 shows another representation of wiper bearing 12 and carrier 10, but viewed from the side. Trough-like recesses 38 in projection 28 are side-by-side in this view, causing annular groove 36 to form a connecting channel 48 that interconnects both recesses 38. Carrier 10 has holes 46 so that at least two holes, i.e., the ones shown in this side view, are positioned directly above connecting channel 48. Of course, projection 28 may also have additional stabilization elements 50. In the illustration, this is sketched as a passage 50 through projection 28 and is generally known in injection technology.

FIG. 4 shows a side view of a wiper bearing 12 that is mounted onto carrier 10.

To mount the wiper bearing, casting material made of zinc or a zinc alloy is injected through bores 46. Within carrier tube 10, this casting material completely fills annular grove 36 as well as trough-like recesses 38 and continues outside carrier tube 10 and is formed into the shape of a ring 52.

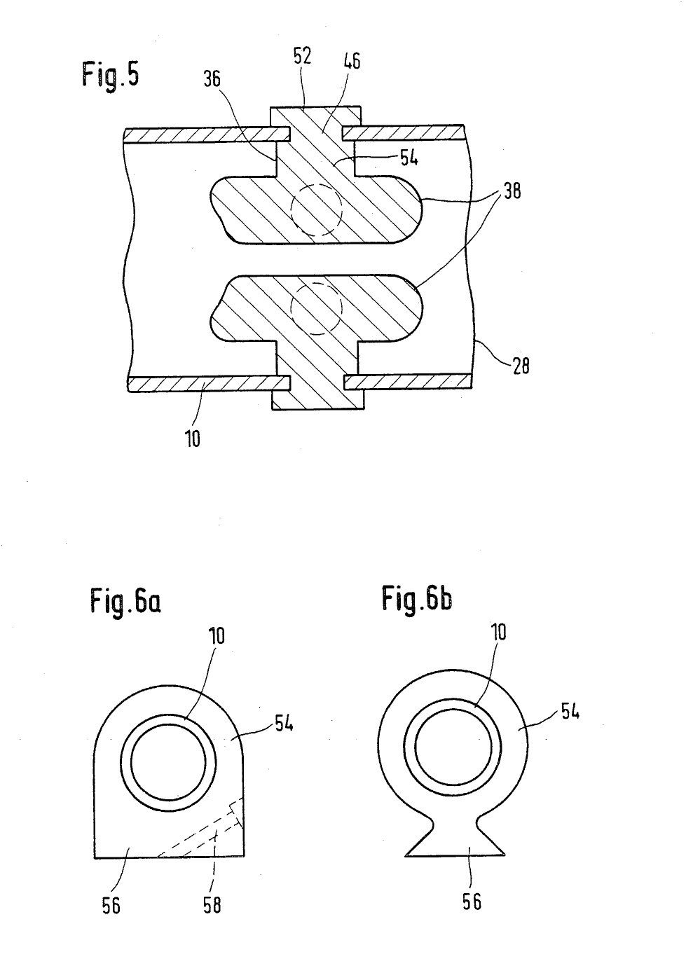

FIG. 5 shows a longitudinal cut through the area of recesses 38 in projection 28. The cut surface in this case passes through the center axis of bearing muff 26 and the center axis of tube 10. Casting material 54 was injected through holes 46 in such a way that casting material fills recesses 38 and circumferential annular groove 36. Outside carrier 10, the casting material is formed into a ring 52 that surrounds the entire carrier.

In addition to cylindrical tubular carriers 10, other forms are also possible for this type of attachment, such as square, rectangular or any other shape of hollow section. To simplify the positioning of holes 46 over annular groove 36, a small dent, for example, may also be pressed into the circumference of carrier 10 at the height of holes 46. Although this requires additional force to insert projection 28 into carrier 10, the sudden release of force helps locate the correct position of holes 46 above annular groove 36, yielding an auto-positioning effect.

In the method according to the present invention, wiper bearing 12 has a projection 28, which, in turn, has a recess 36 designed, for example, as an annular groove. Carrier 10, which is in the form of a hollow section, has corresponding circumferential holes 46 that are located directly above recess 36 when projection 28 is inserted into carrier 10. The end of hollow section 10 into which projection 28 is inserted is placed in a casting mold that is designed to form material around hollow section 10. When casting material is now injected into the casting mold, the material flows through holes 46 into recess 36 and fills it completely. These recesses 38 are typically larger than holes 46, producing undercuts and preventing the injected casting material from falling out. Outside carrier 10, the material is formed circumferentially by the casting mold. This produces an extremely strong and tight-fitting connection between wiper bearing 12 and carrier 10 after cooling, due to casting material shrinkage.

However, the casting material does not necessarily have to be formed in the shape of a ring outside carrier 10. Any other shape is also conceivable, particularly if carrier 10 does not have a cylindrical design.

Because of its flow properties, zinc or a zinc alloy is suitable as casting material 54.

In particular, the casting material is also formable so that it yields an attachment bracket for attaching the windshield wiper system to the vehicle body. This is shown in FIGS. 6a and 6b. This formed material may be provided in advance with attachment holes 58 for attachment means such as screws or rivets. In this case, the material is typically formed into a connecting piece 56, which may have, for example, a rail-like structure.

What is claimed is:

1. A windshield wiper system, in particular for a motor vehicle, comprising a carrier that is at least partially designed as a hollow section (10) and at least one wiper bearing (12) which is provided with at least one projection (28) that has at least one recess (38) and is at least partially inserted into the hollow section (10),
wherein the hollow section (10) has at least one hole (46) located in the area of the recess (38); and casting material is injected through the hole (46) into the recess (38) and extends outside the hollow section (10).

2. The windshield wiper system according to claim 1,
wherein the recess is larger than the hole width.

3. The windshield wiper system according to claim 1 or 2,
wherein, except for an at least partially circumferential annular groove (36) located in the area of the hole (46) in the inserted position, the projection (28) is cylindrical.

4. The windshield wiper system according to one of the preceding claims,
wherein at least one recess (38) extends through the entire length of the projection (28), transversely to its longitudinal extension.

5. The windshield wiper system according to one of the preceding claims,
wherein the projection (28) has at least two diametrically opposed, trough-like recesses (38) which are connected by at least one opening (40) and are positioned transversely to the longitudinal extension of the projection.

6. The windshield wiper system according to one of the preceding claims,
wherein the hollow section (10) is designed as a tube, and the casting material extends at least largely in the shape of a ring outside of the hollow section (10).

7. The windshield wiper system according to one of the preceding claims,
wherein the hollow section (10) has multiple holes (46) that are largely uniformly distributed along its circumference.

8. The windshield wiper system according to one of the preceding claims,
wherein the casting material is made of zinc or a zinc alloy.

9. The windshield wiper system according to one of the preceding claims,
wherein the casting material is formed to yield an attachment bracket for attaching the windshield wiper system.

10. A method for manufacturing a windshield wiper system, in particular a windshield wiper system according to claim 1,
wherein a wiper bearing (12) having at least one projection (28) that includes at least one recess (38) is inserted into a carrier (10) that is at least partially designed as a hollow section; and the hollow section (10) has, in the area of the at least one recess (38), at least one hole (46) through which a casting material is injected, this material extending to the outside of the hollow section (10) and being cured.

11. The method according to claim 10,
wherein the casting material is formed at least into a ring segment.

12. The method according to one of claims 10 through 11,
wherein zinc or a zinc alloy is used as the casting material.

13. The method according to one of claims 10 through 12,
wherein the casting material is formed in such a way that an attachment bracket is produced for attaching the windshield wiper system.
